(19) United States
(12) Patent Application Publication
(10) Pub. No.: US 2002/0046084 A1
(43) Pub. Date: Apr. 18, 2002

(54) REMOTELY CONFIGURABLE MULTIMEDIA ENTERTAINMENT AND INFORMATION SYSTEM WITH LOCATION BASED ADVERTISING

(76) Inventors: SCOTT A. STEELE, LINDENHURST, IL (US); WILLIAM P. ALBERTH JR., CRYSTAL LAKE, IL (US)

Correspondence Address: MOTOROLA, INC., 1303 EAST ALGONQUIN ROAD, IL01/3RD, SCHAUMBURG, IL, 60196

(21) Appl. No.: 09/414,121

(22) Filed: Oct. 8, 1999

(51) Int. Cl. G06F 17/60

(52) U.S. Cl. 705/14

(57) ABSTRACT

An internet radio for portable applications and uses such as in an automobile. The internet radio allows access to a host of audio, visual and other information. Normal radio channel function is provided along with programmable content and channel selection, as well as automatic content and channel updating by location and style. Internet access is also provided. Direct or targeted advertising, as well as electronic commerce is supported. Connection to the internet is through wireless communications. Programmability is achieved off-line via a web page and remote computer. Customized information is also communicated to the radio such as stock quotes, travel information, advertising, and e-mail. Onboard global positioning allows for channel updating by location, traffic information, geographic advertising and available similar content

### BACKGROUND OF THE INVENTION

As wireless communication systems have become more popular, the demand for services has increased. However, the cost of services still remains high for many individual subscribers for service. Some network providers have offered services through the use of prepaid services. Although the use of such services prevents overspending by a user, the user ultimately must incur the cost of the usage of the network. Accordingly, there is a need for alternative service offerings of network providers to enable usage on the network.

### BRIEF DESCRIPTION OF THE DRAWINGS

FIG. 1 shows a block diagram of a system overview.

FIG. 2 shows a block diagram of a vehicle multimedia receiver.

FIG. 3 shows a system diagram of an internet gateway network.

FIG. 4 is a block diagram of one presently preferred hardware platform.

FIG. 5 illustrates sample Web configuration elements.

FIG. 6 is a flow chart of the update information flow of the location based advertising of the invention, where FIG. 6(A) is a first half of the flow chart, and FIG. 6(B) is a second half of the flow chart.

FIG. 7 illustrates one presently preferred information pool used with the invention.

FIG. 8 is a flow chart showing the choosing of an advertisement.

FIG. 9 is a flow chart showing obtaining an advertisement.

FIG. 10 is a ladder diagram showing a user initiated update request.

FIG. 11 is a ladder diagram showing a vendor initiated update request.

FIG. 12 is a flow chart showing the shopping list feature of the invention.

FIG. 13 is a flow chart showing a user originated update.

FIG. 14 is a flow chart showing a system originated update.

FIG. 15 is a flow chart showing the process of selecting a user.

### DETAILED DESCRIPTION OF THE PRESENTLY PREFERRED EMBODIMENTS OF THE INVENTION

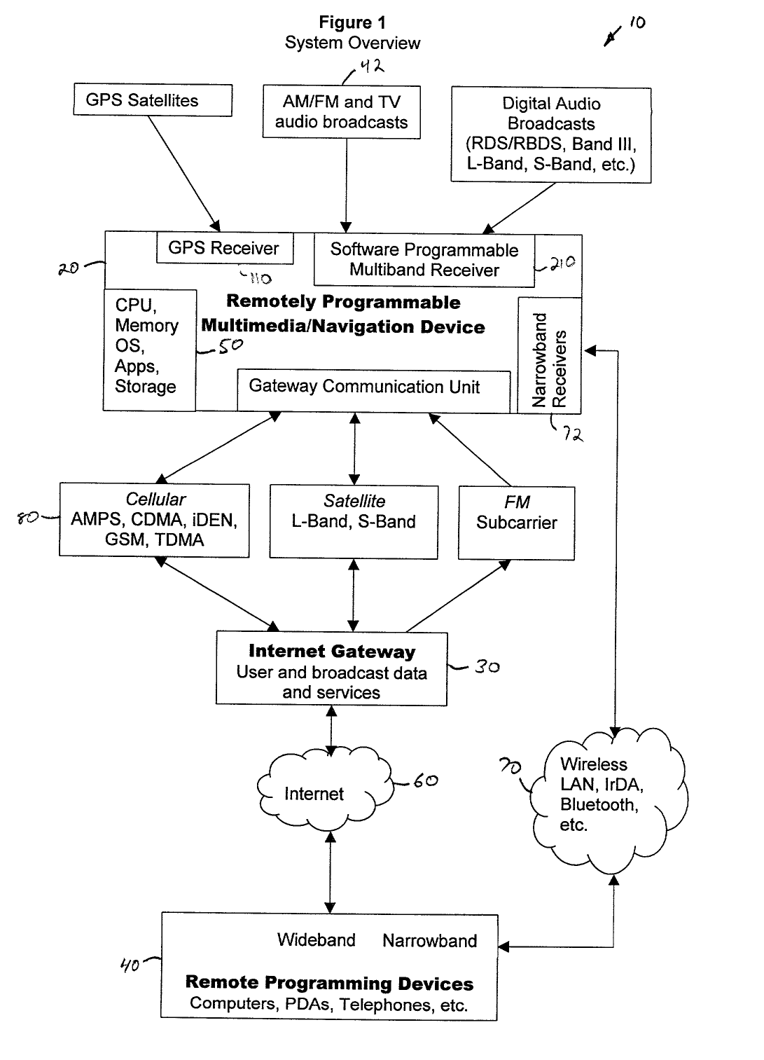

Referring to the drawings, where like elements receive like reference numerals throughout, the invention generally is a computer controlled multimedia entertainment and information system 10. The invention offers information enriched audio broadcasts, personalized information services, integrated access to personal and recorded data, enhanced navigation services and other software expandable services in a vehicle through the use of a wireless Internet connection to an enabling Internet gateway network. As shown in FIG. 1, the invention consists of (1) a remotely programmable, microcomputer controlled multimedia device 20 in a vehicle with a wireless IP address for Internet access, (2) an Internet gateway network 30 that provides programming, information and Internet access to the multimedia device 20, and (3) one or more remote programming devices 40.

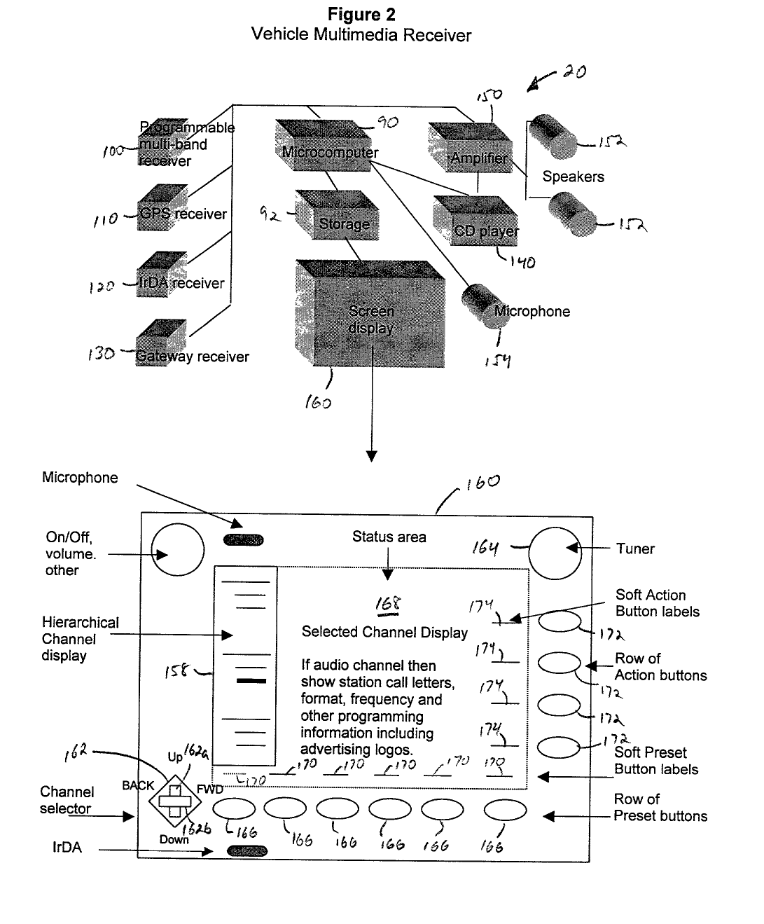

The multimedia device 20 includes a computer 50 that preferably runs an operating system and series of applications that control the operation of the device 20. A user operates an application by tuning to a “channel” in keeping with the known radio paradigm and its user friendly operations. The two types of channels preferably available are audio broadcasts (e.g., AM, FM, TV, digital, Internet audio broadcasts and recorded material) and personal information services (e.g., navigation, email, traffic alerts, etc.). Channels are organized in a hierarchy 158 so any one can be easily selected on screen (see FIG. 2). Audio broadcast channels 42 are organized by the format of the broadcast (i.e., country, rock, talk, etc.) and not by the band or frequency of the station. The listener configures the organization of the channels through a remote device 40 via the Internet gateway network 30.

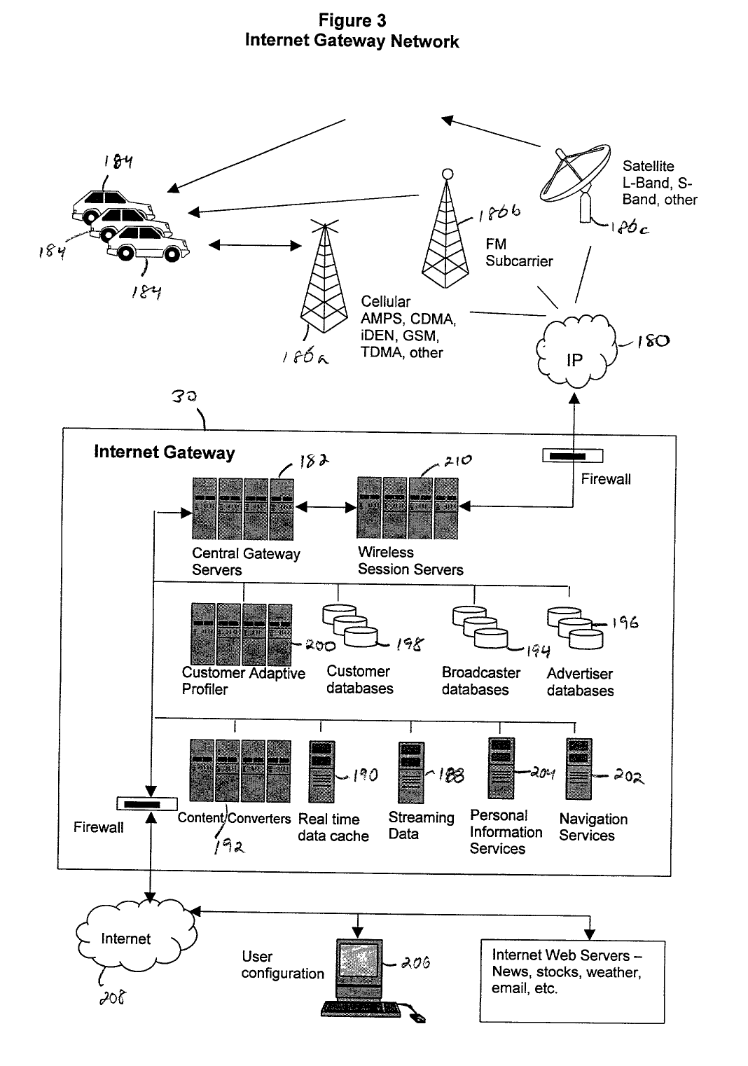

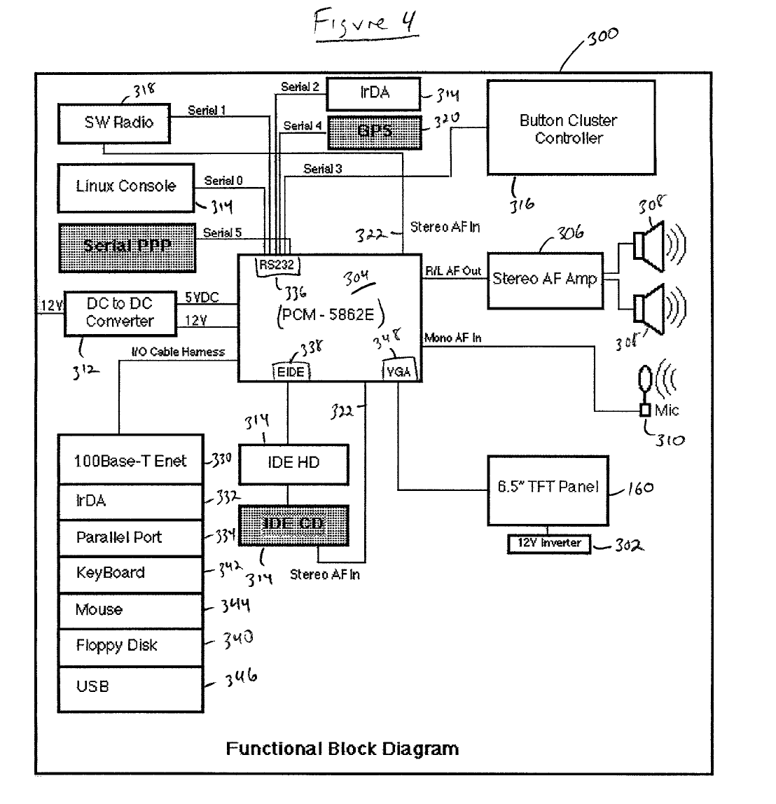

The Internet gateway network 30 is designed to transmit and receive critical information to and from a multimedia device 20 in the vehicle 184 (FIG. 3). Information transmitted preferably includes broadcaster identification that allows the multimedia device 20 to tune to stations by their formats, direct Internet access for streaming audio broadcasts and other Internet content, broadcast advertising database lookup for direct response to advertisements heard in a vehicle, navigation services, delayed digital personalized broadcasts, personal information event notices, and application downloads to create new personal information channels.

Remote programmable devices 40, such as a computer connected to the Internet 60, are used to download information from the Internet gateway network 30 to the multimedia device 20 in the vehicle 184. From a remote device 40, a user can customize the way audio broadcasts and personal information service channels are organized in the vehicle's multimedia device 20, can request new personal information services be downloaded from the Internet gateway 30 to the multimedia device 20, and can retrieve information from the gateway 30 that he has stored there from the vehicle 184. The user can also access his custom profile and billing information records.

FIG. 1 shows many possible wireless communication methods between the vehicle device and the gateway. As those skilled in the art will appreciate, the methods illustrated in FIG. 1 are meant to be representative and do not reflect all possible wireless communication methods that may be employed.

It is thus an object of the invention to allow any AM, FM, TV audio, or digital audio broadcast or any Internet audio broadcast to be easily selected by format (i.e., country, classical, news, rock, talk, etc.) in a vehicle. The user will not need to know the band or frequency of any station to select a broadcast as all types of broadcasts are simply ordered by format. The multimedia device 20 will make the appropriate band and frequency selection when a listener selects a station hierarchically organized under a format category.

It is also an object of the invention to automatically tune to comparable station formats when a vehicle travels out of an area where the existing stations are known to the listener.

It is a further object of the invention that, when a vehicle travels out of an area such that a currently broadcast program fades out, to automatically tune to another station or recorded broadcast playing the same program or at least the same program type.

It is yet a further object of the invention to remotely configure the multimedia device 20 using an Internet gateway network 30 database to download information about all the audio formats and audio broadcasters (e.g., AM/FM/TV/DAB/Internet) possible in a geographic area. The user will choose to show on the radio only those formats and stations he/she desires, blocking out from view all unwanted formats and stations.

It is yet a further object of the invention to add new personal information services (e.g., email, stock quotes, interactive audio games, etc.) to the multimedia device 20 from a wireless Internet connection 60 by downloading applications. Such services are called personal information or data channels in keeping with radio nomenclature as their applications can be used by simply selecting them as you would an audio channel in the main menu or with a preset button.

It is still another object of the invention to remotely configure the system 10 using an Internet gateway network 30 database to present all the personal information services available to the user (i.e., navigation, email, stock quotes, etc.). The user may select only those services he/she desires to use in the vehicle 184.

It is still another object of the invention to allow event driven personal information services to verbalize time specific (e.g., your stock hits new high) or location specific (e.g., traffic incident warning) information using speech synthesis.

It is still another object of the invention to allow recorded compressed audio files and other large data files to be downloaded into the multimedia device 20 from a high speed local area 70 wireless receiver 72. Such downloads may occur at the listener's home or business, or at designated resale locations for such types of data (e.g., record stores, gas stations, etc.).

It is still another object of the invention to allow previously recorded audio broadcasts (usually talk or news oriented programming) to be played back at desired times by recording such broadcasts at a network location and then transmitting these files over a wireless Internet cellular connection 80 at off peak hours to the vehicle 184. Since talk broadcasts result in small compressed files, they can be easily dribbled over a relatively slow speed wide band connection without long delays.

It is still another object of the invention to save enhanced information about selected broadcasts with the press of a button. The information is wirelessly transmitted to a server on the Internet gateway network 30 that can be later retrieved from the user's home or office computer with an Internet connection and web browser.

It is still another object of the invention to allow the selection of live and recorded audio material by format in a vehicle as well as select information services (i.e., phone book, navigation, etc.) by using a combination of a hierarchical menu along with presets that chose a broadcast station or run a selected service application. Selection can be done by pressing directional and preset buttons or by using voice navigation.

It is another object of the invention to present a unique configuration of the system 10 for any number of users so that each user will see only their preferred radio stations and information services when they select their profile at the multimedia device 20.

It is another object of the invention to allow accommodated devices such as notebook computers, PDAs and cellular phones to wirelessly download personal information (i.e., phone numbers, addresses, to-do lists, etc.) into the multimedia device 20.

It is yet another object of the invention to allow phone numbers and addresses downloaded from accommodated devices to be used for navigation and for direct calling.

It is yet another object of the invention to allow purchases to be made of an advertised on air product with the touch of a button.

It is still another object of the invention to listen to advertising customized for listener preferences when playing recorded broadcast programs.

It is still another object of the invention to provide navigation services from the Internet gateway network 30 so maps can remain accurate as they can be centrally updated when highway changes occur.

It is still another object of the invention to provide navigation services from the Internet gateway 30 so that vehicle positions reported by in vehicle GPS devices can be used by personal information services to provide location dependent alerts to the driver.

It is still another object of the invention to allow input of destination addresses for navigation routing from phone numbers or names by doing reverse address lookups from an Internet gateway 30 server and then automatically entering the returned address for the destination.

It is still another object of the invention to allow input of destination addresses for navigation routing from enhanced advertisements that include location information in a data sidecast.

These and other features and advantages of the invention will become apparent to those skilled in the art upon a review of the following detailed description of the presently preferred embodiments of the invention, when viewed in conjunction with the appended drawings.

Following is a description of the system 10 components and configuration.

Multimedia Device 20

As FIGS. 1 and 2 show, the multimedia device 20 consists of a computer 50 preferably having a microprocessor and memory 90, and storage devices 92 that contain and run an operating system and applications to control and communicate with four onboard receivers: (1) a software controlled multi-band AM, FM, TV audio and digital audio broadcast receiver 100; (2) a GPS receiver 110 that continuously reports the vehicle's longitude, latitude and altitude; (3) one or more high-speed, narrow band wireless transceivers 120 for fast transmission and reception of large amounts of data from accommodated devices; and (4) a wide band wireless Internet addressable gateway transceiver 130 to receive Internet protocol based audio broadcasts, new applications known as information or data channels, and configuration data from a gateway network 30 created to service the multimedia devices 20. The in-vehicle wireless gateway transceiver 130 can also send information to the gateway network 30 such as requests for navigation data, advertisement responses, purchase requests, etc. The multimedia device 20 also controls attached conventional multimedia storage equipment such as a CD/DVD player 140 or cassette player (not shown). Sound is output through an industry standard amplifier 150 and speakers 152. A microphone 154 allows for voice recognition commands to be given and received by the multimedia device 20.

The multimedia device 20 preferably also contains and controls one or more digital storage devices 92 to which real-time broadcasts can be digitally recorded. The storage devices 92 may be hard drives, flash disks, or other automotive grade storage media. The same storage devices 92 can also preferably store digital data that is wirelessly transferred to the vehicle in faster than real time mode. Examples of such digital materials are MP3 audio files or nationally syndicated radio shows that can be downloaded from the gateway network 30 and played back when desired rather than when originally broadcast.

As FIG. 2 shows, the multimedia device also uses a LCD, LED or similar suitable display screen 160 for an automotive environment to present information to the user and to control the multimedia device 20. Controls shown on the LCD in FIG. 2 are one possible embodiment for control types and location. Those skilled in the art will appreciate that control types and locations may vary in different implementations of the invention. In one presently preferred embodiment, for example, the display screen 160 includes a 5½ inch 640×480, 216 color VGA LCD display 168. In an alternate embodiment, the display can display as little as two lines of text, whereas an upper limit of the screen display 168 can be as large as the intended application may dictate.

The channel selector 162, tuner 164 and preset button 166 controls shown in FIG. 2 allow the user to broadly navigate all the channels of audio broadcasts and information services available on the multimedia device 20. The channel selector 162 allows a user to manually access and select any of the audio and information channels available by browsing through them (up, down, forward, back) in a hierarchical tree.

A display 158 of a portion of the hierarchical tree is shown on the screen display 168.

The root of the tree, the leftmost part, preferably contains major categories of channels. Possible types of major channel categories could include music, talk, TV audio, recorded audio, personalized directory services and information services. As is explained in detail below, the user can configure the presentation of major categories and subcategories so that he/she sees only those categories of interest.

Under each major channel category, there are preferably subcategories. To see these subdivisions, the user would select the desired major category by pressing the up or down channel selector buttons 162a and then press the forward button 162b when the category desired is highlighted. The user could then see all the channels available under that subcategory in similar fashion and select any of them to play.

For example, under the category of music channels, commercial audio broadcasts could be subdivided into 30+ radio industry standard formats (e.g., blues, classical, county, dance, jazz, rock, sports, talk, etc.). To hear a particular country music radio station in a particular geographic area, a user would select the “Music” category by pressing the up or down channel selector buttons 162a and then press the forward channel selector 162b when positioned on “Music.” Next, the user would use the up or down channel selector buttons 162a to highlight “Country” and would then press the forward button 162b. The user would then see all the country music channels available in that specific area. Moving the channel selector 162 up or down over each channel preferably causes each audio station to play.

Once a user has moved forward in the hierarchical tree, the subcategory or channels displayed will remain visible until the user presses the back channel selection button 162b that moves the user back up the tree one level. For example, to move back from country broadcasts to select other music formats, the user would press the back button 162b and then select another music format. The multimedia device 20 may be preferably configured so that the last hierarchical display and selection the user made is presented when the device is next turned on.

Preset buttons 166 on the display screen 160 are user configurable buttons that allow the user to select any one channel, group of channels or even channels from different categories that can be played or displayed with the press of a single button. For example, a user could configure a preset button 166 to simply play a favorite country station when pressed. The user could also configure a preset button 166 to display all the country stations in a specific area. The user could even configure a preset button 166 to display their favorite blues, country and rock stations at one time on one screen display 168. Once these groups of channels are displayed, the user can play the radio stations by using the channel selector buttons 166. A preset button 166 can also be assigned to any personal information channel application. For example, assigning a new channel (application) that shows all hospitals in an area would result in a map showing the nearest hospitals to the vehicle's current position when the preset is pushed. User defined labels 170 for preset buttons 166 preferably appear on the screen 168 above the preset buttons 166 to indicate their purpose.

The tuner control 164 shown in FIG. 2 flattens the hierarchical tree. Rather than having to step through categories and subcategories to play a channel, by turning the tuner control 164 the user can play each channel one after the other in the order they appear in the hierarchy 158. If a user has configured the device to show only a few categories of channels, this allows fast sequencing through a channel list. Pressing the tuner control 164 preferably causes the device to scan through the channels as a traditional radio would do, playing a few seconds of each station before moving to the next in the hierarchy 158.

Computer programs running in the multimedia device 20 control the action buttons 172 shown in FIG. 2. Action buttons labels 174 and purposes may change from program to program. A button's label 174 indicates its current function. Some examples of action buttons 172 could be: “INFO” to save extended information on something that is being broadcast (e.g., the Internet web address of a band currently playing); “CALL” to call a phone number from an advertisement; “NAV” to navigate to an address from an electronic address book; or “BUY” to purchase an item currently being advertised.

A microphone input 176 on the face of the display 160 allows users to control the multimedia device 20 verbally rather than through the control buttons. Key word recognition software allows the user to make the same channel selections that could be made from any of the button controls. Audio feedback through speech synthesis allows the user to make selections and hear if any other actions are required. Software or hardware based voice recognition and speech synthesis may be used to implement this feature.

Internet Gateway Network 30

FIG. 3 shows a system drawing of the Internet Gateway Network 30. The Internet gateway network 30 preferably consists of standard Internet TCP/IP protocol communications equipment 180 and computers 182 that serve multiple functions. The gateway 30 is designed to provide wireless Internet access to the multimedia device 20 in the vehicle 184, enhance regular audio broadcasts with extended information, and provide personalized broadcast, information and applications to the vehicle 184.

The gateway 30 serves as an Internet Service Provider to vehicles 184 through various forms of wireless transmission 186. Cellular access is expected to provide the initial form of wireless transmission with satellite transmissions to follow. In some implementations, requests from the vehicle 184 may come through the cellular network 186a while responses may be routed through FM sub-carriers 186b or faster satellite networks 186c. Wireless session servers 210 are preferably dedicated to maintaining connections with the rest of the gateway network 30 no matter what form of transmission is used.

To insure adequate throughput to vehicles 184, the gateway network 30 will cache most requested Internet data in a real time data cache 190, as well as convert retrieved Internet content through content converts 192 for appropriate display or verbalization on the multimedia device 20. Dedicated streaming data servers 188 will be used to broadcast personalized audio broadcasts to the vehicle 184, as well as rebroadcast other Internet audio broadcasts.

The Internet gateway network 30 also maintains a database management system to control several important system databases. The gateway 30 provides a broadcaster relational database 194 containing information about all AM, FM and TV analog audio broadcasts that can be received in a vehicle 184 within the host nation of the gateway network 30 (e.g., radio station call letters, programming format, frequency assignment, program listing, etc.). Related databases (not shown) may maintain similar information for new digital broadcasters such as satellite radios who transmit over large geographic areas and for international Internet audio broadcasts. Information in the database concerning constantly changing program listings (e.g., song play lists, etc.) are preferably continuously updated throughout a day.

Advertising databases 196 provide information about advertisements (e.g., advertiser name, ad content, time of ad run, etc.) that are inserted into real-time radio broadcasts and into digital personalized broadcasts. In one embodiment of the system 10, when a user wishes to purchase a product or get more information about a product while in the vehicle 184, the user can press a “BUY” or “INFO” button on the multimedia device 20, which transmits to the gateway network 30 the location of his vehicle 184 (GPS derived), the date and time of the button press, and the channel selected. The advertised item is then looked up in the database 196, and the user is charged for its delivery or is sent more information about the product. In an alternative embodiment, enhanced advertising information for short periods of time may be pushed to the multimedia device 20 from the gateway 30 at set intervals. Only those ads offering immediate purchase or additional information will preferably show indicators for these actions.

User profile databases 198 contain information about the user's system preferences (e.g., channels selected), billing information and a purchasing interest profile. Information in advertising databases can be compared against a user's purchasing interest profile through an adaptive profiler 200 so that advertisements inserted into delayed personalized digital broadcasts mesh with that individual's buying interests. If there are multiple users on one account (e.g., family members) then each user will preferably have a unique profile in the user database 198.

Users are also allocated storage space on the gateway's servers for their own use. Enhanced live or recorded broadcasts that contain information the user may want to reference later (e.g., the web address of the band currently playing) allow the listener to press a button on the multimedia device 20 to transmit and store that information on their user pages on the gateway 30.

The gateway 30 also provides navigation services through a dedicated computer 202 to the vehicle 184. The vehicle 184 provides location information from its GPS receiver 110 (FIG. 2) to the gateway 30, and the gateway 30 in turn provides mapping services to the vehicle showing travel routes or locations of interest. Coupled with the advertising database 196, drivers can see map locations related to recent advertisements and get navigation guidance to these locations. For example, the driver could get directions to the nearest chain restaurant whose commercial just played offering a lunch special.

The gateway 30 also transmits other software applications to the vehicle 184 for use in the multimedia device 20. These applications are referred to as channels and comprise the personal information services of the system 10 (navigation, email, etc.). These applications or channels can be downloaded to the vehicle 184 from a computer 204 at any time to instantly add to the features of the multimedia device 20.

The gateway 30 further transmits events to the vehicle based on preferences provided by the user in a user profile stored on a stand alone personal computer 206. Such events could be, for example, stock market alerts (i.e., set an alert when a stock reaches a set value), traffic alerts based upon the user's route (notifies of any delays as they happen in real time on the route), email messages, or the like.

Remote Programming Devices 40

Several types of remote programming devices 40 may send different types of data to the multimedia device 20, as shown in FIG. 1. Such devices 40 can also receive different types of data from the multimedia device 20 through the Internet gateway 30. Configuration data determines which formats of audio broadcasts (i.e., AM, FM, DAB, Internet broadcast) and information services (i.e., applications for navigation, stock reports, weather reports, etc.) can be received by the remote device 40, as well as what channels are associated with preset buttons 172 (FIG. 2).

Configuration data is preferably sent to the multimedia device 20 through a computer 206 with an Internet connection 208 using a web browser, as shown in FIG. 3. Due to the large number of possible analog, digital and Internet based broadcasts available for reception by the multimedia receiver 210 (FIG. 1), choosing from the huge variety of broadcasts is less complicated if it is preprogrammed or preconfigured in advance by the user through a remote computer 206 rather than from the multimedia device 20 itself. The user would log onto the Internet 208 in a manner generally known in the art and then access the configuration web page of the Internet gateway network 30. Once the user has configured the web page selections as desired, he/she could submit the changes. The new configuration could then be transmitted to the multimedia device 20 in the vehicle 184 from the gateway network 30.

Personal directory data could be transferred locally to the computer 206 using such local wireless technology as IrDA or Bluetooth. Examples of such remote devices 40 include notebook computers, PDAs or cellular phones. Examples of data transferred include phone books, address books and to-do lists. Those skilled in the art will appreciate that other remote devices 40 and data transferred are contemplated without departing from the essential spirit and scope of the invention. The computer's I/O controller (not shown) would constantly scan for transmission types it recognizes and once one is found it would initiate a data transfer.

Larger recorded audio files could be transmitted to the multimedia device 20 from embedded computers with fast, high bandwidth local area connections. An example of such a transfer would be the purchase of an MP3 audio file from a retail reseller such as a record store or gasoline station. Another example would be the transfer of personal MP3 files from the user's home computer 206 connected to the vehicle multimedia device 20 through an IEEE 802.11 standard wireless LAN.

Hardware Platform Description

Referring now to FIG. 4, one presently preferred hardware platform 300 is shown broken up into the various sections that make up the multimedia device 20 itself. Following is a description of the functions of the platform 300, as well as a functional description of one presently preferred front panel display 160. The front panel 160 is designed by Prisma Design International, Inc. In one embodiment, the front panel 160 may be a 6½ inch TFT flat panel displays powered by a 12 volt inverter 302.

The hardware platform 300 includes the components implementing the multimedia device 20. The multimedia device 20 is preferably built on an IBM PC compatible platform, running the RedHat version 5.1 (Manhattan) Linux operating system. Many portions of the operating environment are implemented in the Java language running in a VM process.

As shown in FIG. 4, the hardware platform 300 includes the following sub-assemblies or components. Principally, the hardware platform 300 includes a motherboard 304, a flat panel display 160, a stereo amplifier 306 and speakers 308, a microphone 310 and audio inputs 322, a power supply 312, peripheral devices 314, a button controller 316, a shortwave radio 318, and a global positioning system receiver 320. Each of these components is described in further detail below.

Multimedia Motherboard 304—The motherboard preferably comprises a PCM-5862E Intel Pentium motherboard sold by Advantech Co., Ltd. The motherboard 304 preferably also includes most of the hardware devices required for the hardware platform 300, such as:

100 Base-T 330

IrDA 332

Parallel Port 334

4 RS232 serial ports 336

IDE 338

Floppy disk 340

Keyboard and Mouse 342, 344

USB 346

CRT/TFT VGA controller 348

Sound (not shown)

PC/104 expansion (not shown)

1 PCI slot (not shown)

TFT panel 160—The platform 300 display preferably is a 4″ 640×480 256 color VGA panel. The LCD display preferably runs from 12V DC.

Stereo AF Amplifier 306 and Speakers 308—The platform 300 preferably includes an after market car stereo amplifier 306 capable of driving 5 speakers 308. The speakers 308 selected and placement is done by Prisma Design. The amplifier 306 has outputs for 2 right channels, 2 left channels, and a sub woofer.

Microphone 310 and Audio 322 inputs—The microphone 310 and audio 322 inputs will feed into the sound subsystem of the computer 304. Some type of mixer is preferred. The presently preferred embodiment uses the Mic input, and Computer 304 sound out. Additional hardware may be required for Microphone audio preprocessing.

DC to DC converter 312—The system runs on nominal 12 V DC (up to 13.8 volts actual). The computer 304 requires 7 Amps at nominal 5 Volts.

IDE devices—A 2.5 inch laptop 4 Gigabyte drive is used. Cabling is also provided for a CDROM hookup.

Button Cluster Controller 316—A microcontroller that takes the button events and turns them into serial codes.

Linux Console—The first serial port 366 is preferably assigned to the Linux console.

SW Radio 318—A radio capable of tuning the radio spectrum under RS232 computer control. The radio preferably provides stereo output when in the domestic FM band.

GPS 320—Serial input from a GPS receiver 110 (FIG. 2).

Multimedia Device 20 Configuration and Operation

While the multimedia device 20 can be operated with default settings, it should be preferably configured by the user after purchase for best use. Using a remote computer 206 with an Internet connection 208, the user preferably logs into the Internet gateway network 30 in a known manner. If the user has never created an account before, he/she will first answer a series of questions to create a user profile. The user registers information about the multimedia device 20 itself (e.g., identification number, model, etc.), provide billing information, provide information about the vehicle 184 if the device is an OEM installation, and complete the purchase interest profile so that advertisements can be directed to his vehicle 184 that meet the user's buying needs.

Next, the user indicates where the multimedia unit 20 is currently located. This information will be used to access the broadcaster database 194 and retrieve tuning and other related information about those local stations that may be received in this area. If the user subscribes to a digital satellite broadcast service, that broadcaster's channels will also be retrieved. Internet audio broadcasts will also be shown.

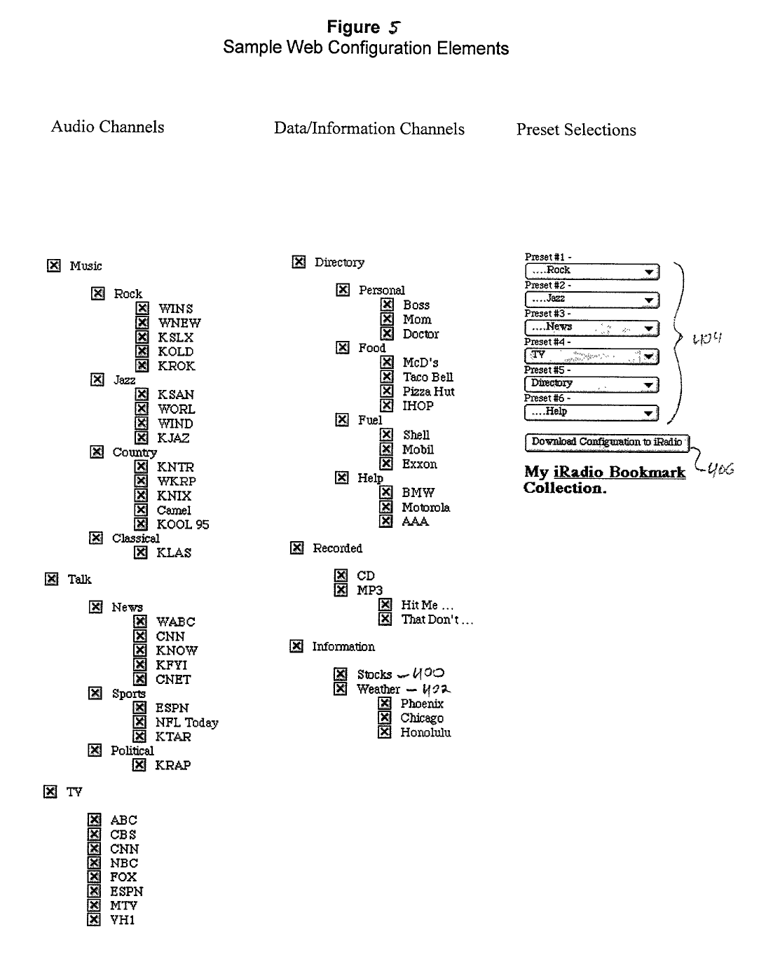

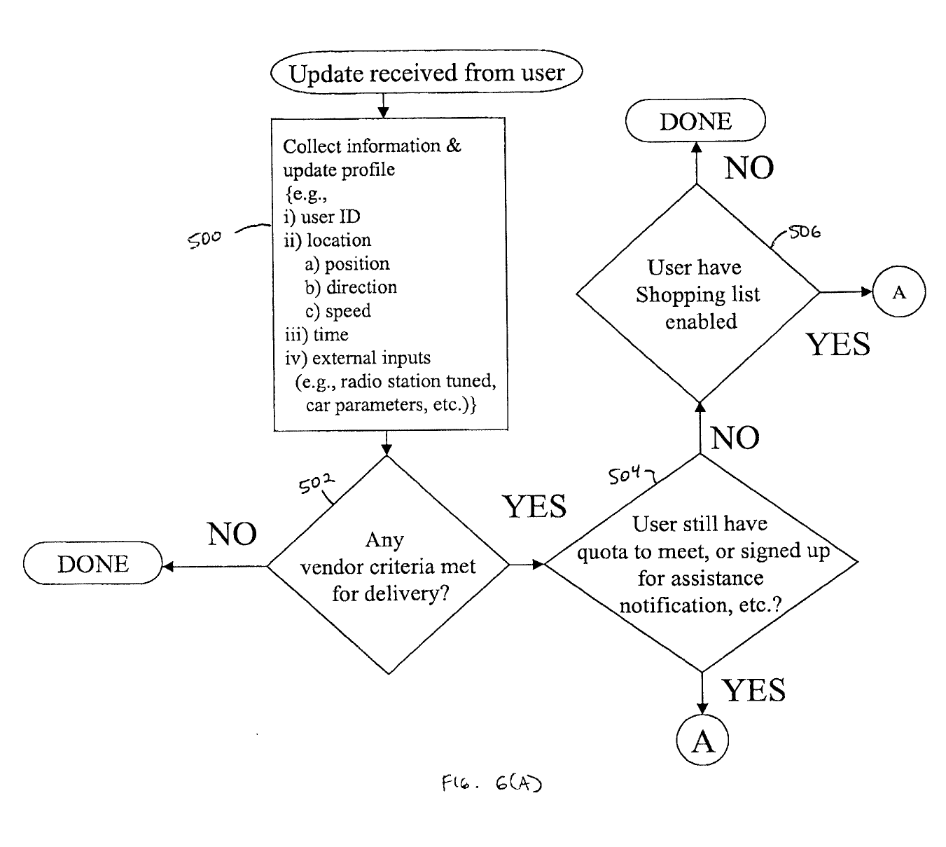

The user will then see a web page that will be dynamically created. It will contain all audio channels available in his area organized by format. FIG. 5 shows examples of the types of information that may be seen. By default, all formats and stations are selected. The user will then be able to check on or off which formats and individual stations he/she prefers to see on the device 20. Any format or station that is turned off will not appear on the radio display.

The user will also select those personal information channels (applications) such as stock reports 400, weather reports 402, traffic reports (not shown), etc. that the user wishes to use. These applications will be downloaded to the multimedia device 20 once the configuration session ends. The services shown will preferably grow over time as new features are added.

As shown in FIG. 5, the user can also configure the preset buttons 166 on the multimedia device 20 to select one or more channels 404 when a button 166 is pressed. Last, the user presses an option button 406 to configure the device 20 with his settings. All the formats and stations selected are transferred to the user's profile pages on the Internet gateway 30. The gateway 30 will next awaken the multimedia device 20 and then transfer the configuration data to the multimedia device's local database 198 and also download any new service applications to the device 20.

When the device 20 is instructed to tune to a particular local or satellite station in the vehicle 184, its tuning program will retrieve the band and frequency information contained in its local database of stations 194, and then tune the software programmable receiver 100 (FIG. 2) with this information. If the channel is an Internet audio broadcast, the tuning program will create a wireless Internet connection with the gateway 30 using the designated URL in its local database 194 as the source of the streaming broadcast, and will then run an appropriate application to play the broadcast.

If the vehicle 184 moves out of the geographic area used in the original configuration and so loses signal from its local stations, several corrective possibilities may happen. The user may manually request from the multimedia device 20 a recalibration of local audio stations. The location of the vehicle 184 from the GPS receiver 110 is sent to the gateway 30 and a new set of local stations are transferred back to the device 20 from the gateway broadcaster database 194. Another possibility is that if the playing station experiences a set amount of drift, that event will automatically trigger a request for a local station recalibration. It could also request from the broadcaster database 194 at the gateway 30 a list of any other receivable stations that are currently broadcasting the same programming as the fading station.

Location Based Advertising Business Method

Using the computer controlled multimedia entertainment and information system 10 described above or some other suitable network, a method for transmission of location based advertising is provided. Although the following description refers to multimedia entertainment and information system 10 and multimedia device 20, the location based advertising methods described in this application could apply to any communications system or any wireless communication device, including without limitation, pagers, cellular phones, two-way radios, PDAs, laptops, etc. The key aspect of this method is trading location based consumer preference or behavior profile information on various products or services for a number of advertisements transmitted to the system 10. Such a method is based upon advertisement selection criteria, user location information, and proximity of users and vendors.

In particular, the present invention contemplates a method of providing service or products in a communication network comprising the steps of providing a plurality of service or product options to an end user; consumers will receive services or products in exchange for receiving ads. The plurality of service or product options could include such things as location based services (roadside assistance, navigation, etc.), news updates, sports, weather, stock quotes, e-commerce transactions, web surfing minutes, discounts on products, frequent flier miles, free products (CD's, electronic equipment, gasoline), etc. in exchange for the end user receiving ads (voice, text or other medium) to a communication device. Alternatively, a plan could include a predetermined set of services or products provided to the end user in exchange for receiving a predetermined number of ads during a predetermined time frame or a number of ads within a predetermined range fitting said user's profile. The ads could be required to be received over a predetermined time frame to encourage more system usage.

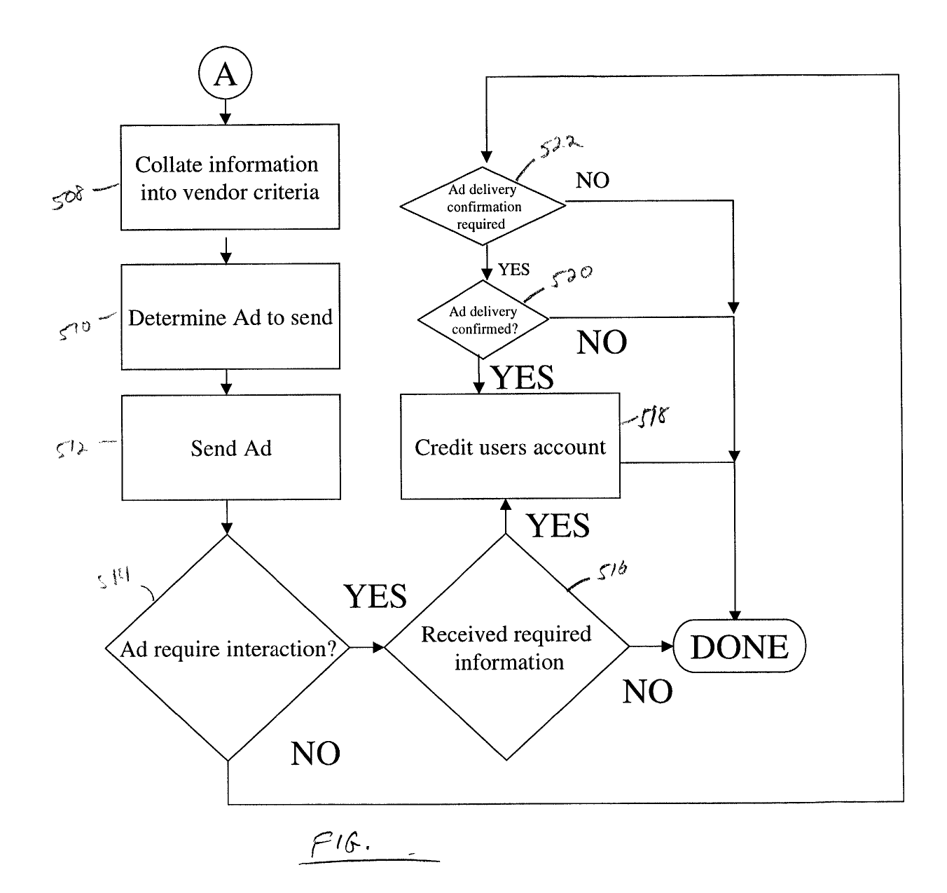

Referring first to FIG. 6, a flow chart of the update information flow of the location based advertising method of the invention is provided, where FIG. 6(A) is a first half of the flow chart, and FIG. 6(B) is a second half of the flow chart. What triggers this diagram is an update received from the user. An example of such a request would include a message received by the system 10, where the message was transmitted from the multimedia device 20. This message could be sent by the system 10, or sent automatically by the device 20 or manually by the user interacting with device 20 or some other device communicating with system 10. In connection with FIG. 6, it doesn't matter how the system 10 received the message; FIG. 6 illustrates the processing of the message—the mechanics of how the message was caused to be generated, is addressed in greater detail below.

The first step 500 shown in FIG. 6(A) performed by the method is to collect information relative to the user. This information can come from the message that was received from the user. For example, the information can include a user identification number associated with a remote location; location-related information, such as position, direction and speed of the user; time (this data can come internally from the system 11); and potentially other external information that the system 11 may request from the user. Examples of this additional information is described in greater detail below. System refers to the electronic system which can create or forward messages to users. In some embodiments this could be a computer, an interconnected system of computers and trans actors, or just software residing on an existing computer system. System is also used to refer to the provider of this service.

The next step 502 performed by the method is to access a database of vendor criteria (not shown) to determine if data exists to compare to the user information received by the system 11. An example of such vendor criteria is whether the vendor is looking for customers who meet certain demographics. Another example might be a particular vendor that the system is going to be sending an ad for may be looking for potential customers that are within a defined (e.g., one mile) radius of a retail location and is also presently driving in a vehicle. These are but a few examples of the criteria that a vendor may be looking to place adverstisements on, and those skilled in the art will appreciate than many other examples and criteria exist without departing from the essential spirit and scope of the invention.

This step 502 thus determines if the information that has been received by the system 11 from the user falls in line with any of the vendor criteria. So, the system 11 compares each of the vendor's criteria that subscribe to the service provided, for this particular update that was received from a user, and determines whether the vendor criteria match the user information. If not, there is nothing else for the system to do with this particular user update, and the method terminates. In an alternate embodiment of the invention, the system 11 may go back and update the user's profile (described above) with any newly received information contained in the user update.

If a match is generated for one of the vendor's criteria, then the system 11 next determines at step 504 if the user needs to receive some ads to meet his or her preferably required quota of advertisements for subscribing to the system 11. If the answer to that question is yes, then program flow moves onto the second half of the flowchart (FIG. 6(B)). At step 508, the system 11 formulates the information in a format where it can be matched against the vendor criteria. With that, the system 11 can proceed to step 511 to determining which advertisement to send to a user in response to the user update. With a given vendor, there may be multiple ads that can be sent in response to a particular user update. Examples of these ads are described in greater detail below.

At this point, the system 11 determines that an ad exists that is ready to be transmitted to the user. At step 512, the ad is sent to the user. In the preferred embodiment, the system 11 also determines at step 514 whether interaction from the user is necessary in order to obtain further information. This is done to ensure, for example, the user is in fact reading the ad and the ads delivered aren't just going by while the system 11 is turned on overnight just to make sure the user meets his quota. So, on some of the ads if they require interaction, the system 11 determines if it has received the required information from the user yet or not.

Assuming that the system 11 has received the required user information (step 516), the method proceeds to credit the user's account at step 518 and then terminates. If the particular ad selected did not require any user interaction, however, then the method checks to ensure that a confirmation that the ad was delivered is necessary or required by the vendor at step 522. On certain messaging systems that can be used as remote programming devices 40, the confirmation may be transmitted back to such a device 40. If no confirmation is required, the method terminates. If a confirmation is required, then the method determines if the ad was in fact delivered at step 520 and, once confirmation is received, the program credits the user's account at step 518 from a running tally of ads received, and then terminates.

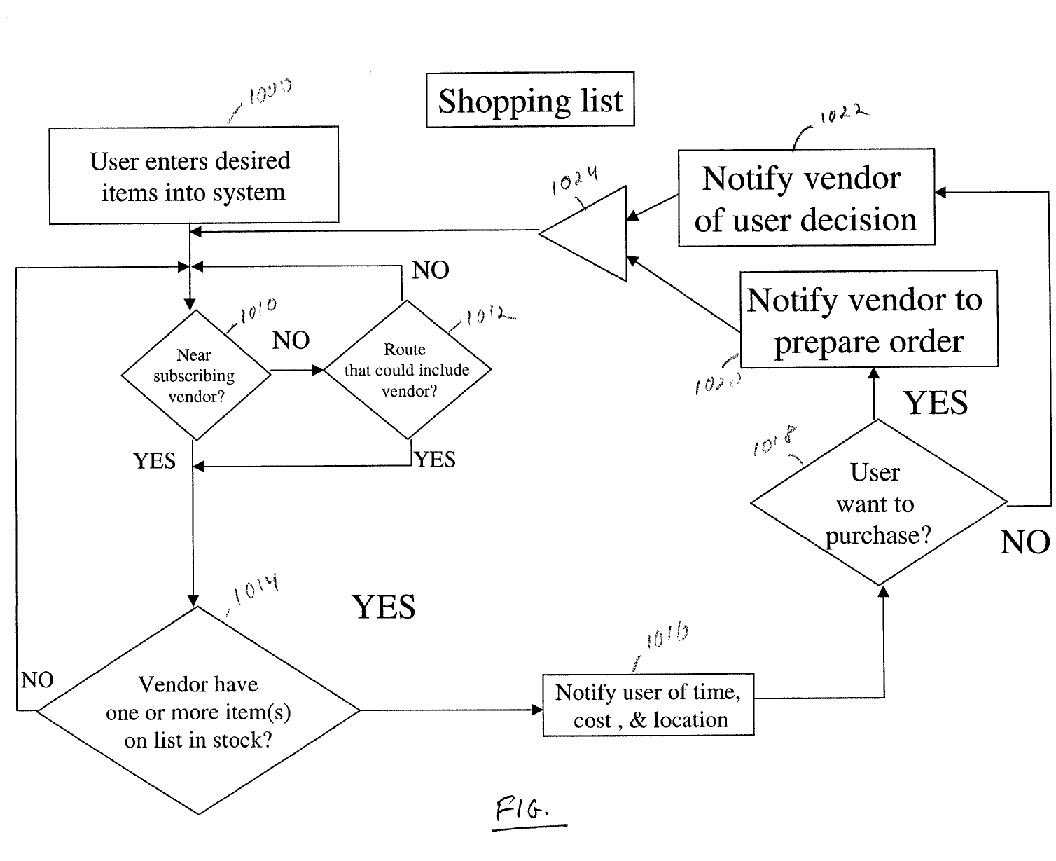

Returning to FIG. 6(A), if the user still needs to receive a certain number of ads to meet his or her periodic quota, the system 11 repeats the above procedures. If the user has received all the ads that were needed to be received to meet the subscription quota, in the preferred embodiment of the invention the method proceeds on the assumption that the user is not interested in receiving any more ads during this interval, whatever it is. However, in the preferred embodiment, the system 11 allows for an override feature where the user has engaged the shopping list feature shown in step 506. In that embodiment, the system 11 still allows the user to receive ads because that provides a benefit to the user as opposed to something the user is doing just to get this service. The shopping list feature is described in greater detail below in connection with FIG. 12.

As those skilled in the art will appreciate, the received user information may come at a different point in time. So, when that information comes in, because it is coming from a different part of the system 11, the method still needs to credit the user's account when the information is received.

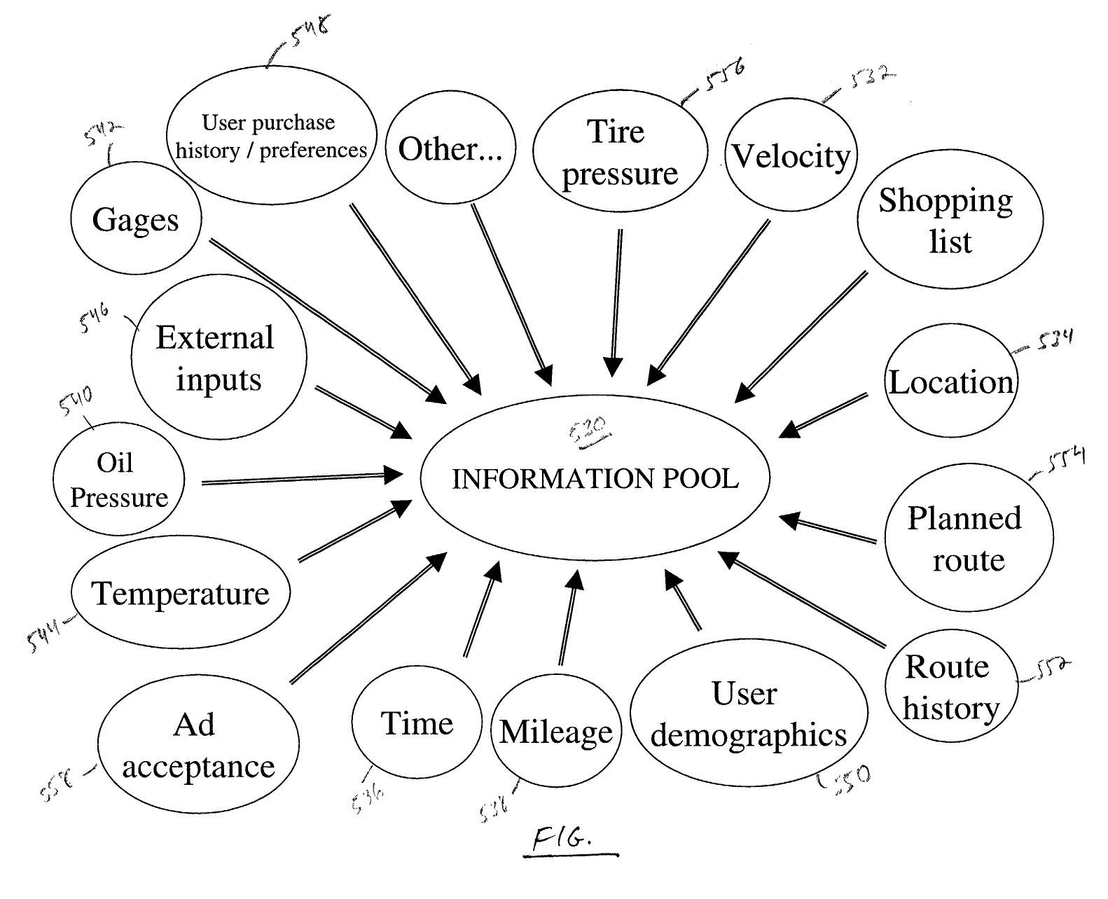

Referring next to FIG. 7, a listing of presently preferred information that is received from a user to form an information pool 530 is illustrated. Some things already mentioned include velocity 532 and position/location 534 of the user, time of day 536 and mileage 538. If the system 11 is tied into an automobile 184, the information pool may further include oil pressure 540, gauge data 542, and interior car temperature 544. Outside temperature could be obtained either from the vehicle or from some external input 546 like a weather channel web site. Those skilled in the art will appreciate that myriad different kinds of information can come into the information pool 530.

An example of how the information pool 530 is used by the system 11 would include, in the case where a chain of automotive oil change retail stores subscribe as a registered vendor for the system, the vendor may want to push an ad anytime anybody is within one mile of a retail location. Some of the triggers the system 11 can provide to the retailer in the form of user information thus includes whether the user's oil pressure light is on. If so, then the vendor may want to send the potential customer an oil change ad. Likewise, if the vendor obtains information on the interior temperature of the vehicle and that information is coupled with information about outside temperature—and the outside temperature, for example, is 115° while the interior temperature of the car is 95°—instead of sending an oil change ad, same vendor may prefer to send an air conditioner recharge ad. Similarly, if tire pressure 556 is low, a vendor may want to send an ad that tells a potential customer to come in and get their tires checked.

In addition, the information pool 530 need not always exist by pinging or polling the user. For example, a user's purchase history preferences 548 can also be included. This information, however, is not information that can be readily obtained from the user. Rather, this is information that the system 11 can compile over time and keep resident in a memory. An example of the method of accumulating historical purchasing data may be that a user historically responds to 50% of ads sent so the system 11 can start getting ratings on how valuable is this person to the program, as well as what target advertising seem to work better for a particular user. Most suppliers/vendors look for a particular type of customer, so such ad acceptance information 558 is valuable.

Some of the information contained in the pool 530 may relate back to some of the demographics 550 of the individual. If the user has small children, then the system 11 can send the user a McDonalds' ad when the user is within range of a McDonald's store. Alternatively, a negative database con be compiled so that McDonalds may choose to not target a childless person with an ad and not waste the time and expense if the demographics do not support the ad. This type of information also overlaps with the location data 534. If, for example, the system 11 knows that a particular user is parked outside of a school for a period of time (e.g., two minutes), the method can draw the conclusion there that that user must have some children that are in that school. Again, that conclusion would be one of the criteria used in selecting which ad to send. The system 11 can also look at the history of that type of information. If the system 11 sees the user stop outside a school every day for 10-20 minutes, the system 11 can use that kind of information for route history data 552 or route planning 554.

As mentioned above, target advertising can be temporal rather than spatial in nature. The system 11 could use time of day information to decide whether to send an ad. For example, a coffee shop may want to send ads between the hours of 7 a.m. and 11 a.m. only. If a user's route everyday is through a certain district or area, the system 11 has a statistical chance of knowing where the user is going to be and a what time. The system 11 can start feeding the user ads ahead of this time period without even knowing a precise location. Again, the system 11 monitors the user's route history everyday and sees that the user pulls into a donut shop, so the system 11 concludes that the user is probably stopping for a donut and a coffee. A competing coffee shop may want to start pinging that user with an ad as soon as he or she is pulling out of the driveway everyday.

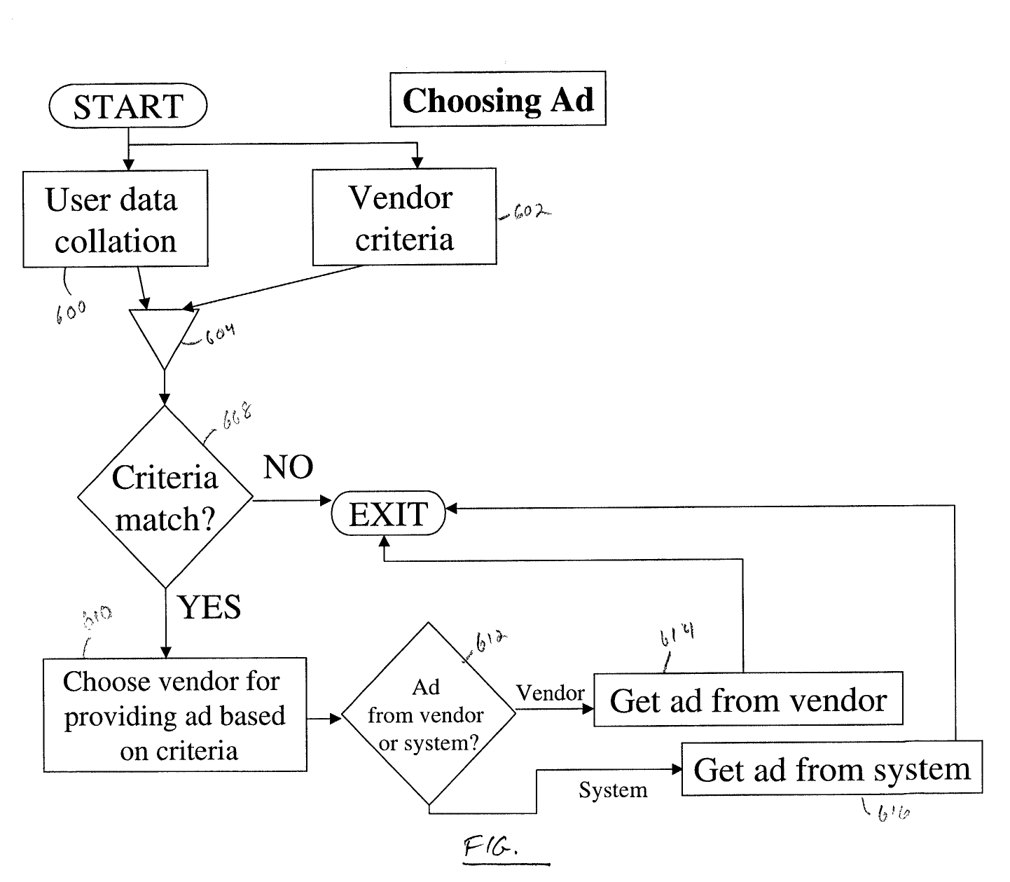

FIG. 8 is a flow chart showing the steps of choosing the ad, which is shown generally at step 510 in FIG. 6(B). First, the method proceeds to collate user data at step 600. This information is combined together at step 604 with the vendor criteria (step 602) again matching the appropriate types of information. The system 11 determines at step 606 if there is a criteria match, as set forth above. If not, the method terminates as indicated above. There is thus no vendor, and no ad to choose from.

If there is a match, there may be one or more ads that match, so the method proceeds to choose the vendor providing the ad based on the criteria at step 610. Some of the criteria here again relates to the different vendors. Part of the information may also include the relationship the service provider has with the vendor. For example, if a specific vendor is guaranteed a certain number of ads per month and because of the narrowness of this vendor's criteria, even though they don't buy very many ads per month, their criteria is so narrow that the system 11 has to let them bubble to the top for a particular user.

The next step 612 the method performs is to determine if the ad will be coming from the system or is it actually going to come directly from the vendor. The invention contemplates four sources for ads. Static ads are resident on the system 11. There may be multiple different ads for a different vendor that are chosen by a given criteria, but the ads themselves are static. These ads could also be updated at some point possibly in time, but they remain on system 11. In contrast, dynamic ads are created on the system 11 using some of the criteria to actually change the content of the ad. For example, instead of just sending an ad that says: “Come into Dunkin Donuts”, a dynamic ad may read: “Bob, come into Dunkin Donuts, come and get a cup of coffee.”

Likewise, the same type of mechanism is available back at the vendor where, instead of hosting the ads themselves on the system 11, the ads actually come directly from the vendor's system (not shown). The method thus sends the vendor criteria that was deemed a match to its criteria. Information is sent back and forth. Ultimately, the vendor sends the ad to be sent to the user.

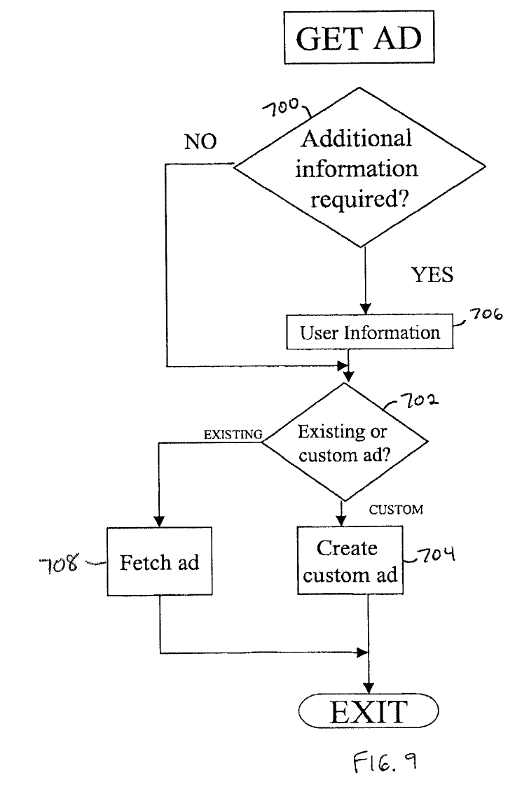

Referring next to FIG. 9, a flow chart of the method of getting an ad is provided If there is no additional information required from the user (step 700), the system 11 determines if this is an existing ad or a custom ad at step 702. If it is an existing ad, the method retrieves and returns the ad at step 708. If it is a custom ad, then the method proceeds to create the custom ad at step 704 based on the update information (FIG. 6) and possibly some additional information. The custom ad is then created.

Backing up to the additional information required step 700, if the system 11 needs more information from the user is proceeds to obtain that information at step 706. For example, perhaps gauge information from the vehicle is required, but that information was not supplied in the original update message. The system 11 requests and retrieves the additional user information.

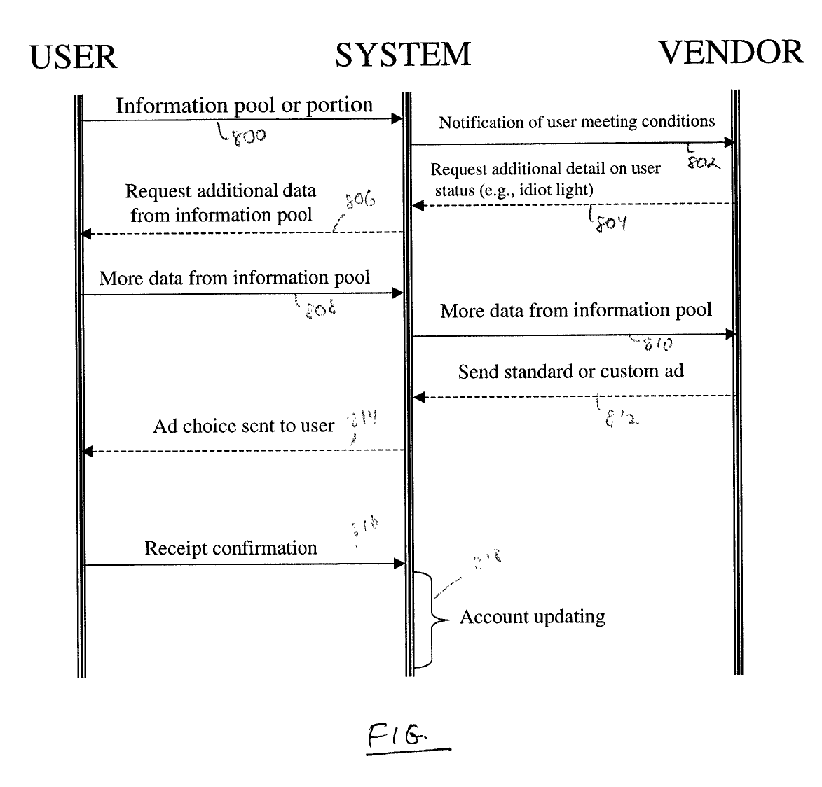

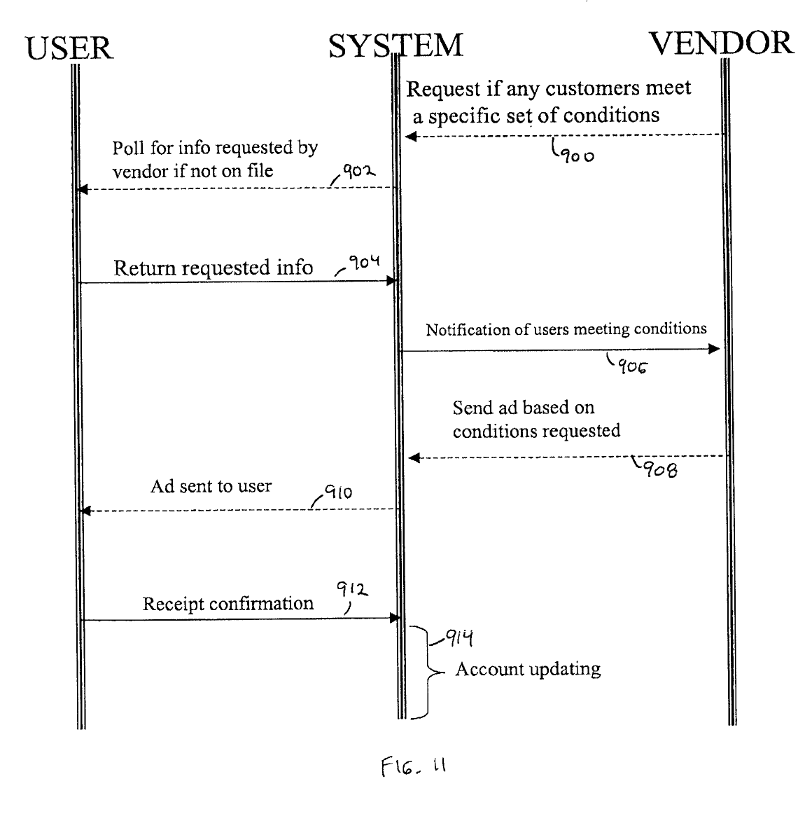

FIGS. 10 and 11 are ladder diagrams that show alternate preferred paths for sending and receiving information over the system 10. In FIG. 10, the user autonomously sends 800 in the information to the system 11. The user thus sends in information to the information pool, or more likely a portion of the pool since the pool is preferably very large and transmission of all pool information may tie the system 11 down. Then, once the information is received and collated by the system 11, the system 11 notifies the vendor 802 that there is a user that meets their requirements. The vendor may then respond and request additional detail 804, such as what is the mileage, temperature, or gauge information related to the user. The system 11 can then poll the user 806 for that information requesting specifically that type of information. As a result, more data from the pool gets sent back 808 to the system 11. Or, more data to add to the pool is sent back from the user. That data is then sent on to the vendor 810 by the system 11. The vendor can then decide what they want to do with it, and send a standard or custom ad. The vendor then notifies the system 812, the system sends the ad to the user 814, and the user, preferably, sends a receipt or a confirmation of the receipt back to the system 11. Finally, some accounting steps are performed 818 on or at the system 11.

Alternatively, FIG. 11 shows that the vendor or the system 11 itself can send a request to the user. Either way, it can be requested if anybody needs a product or service 900. The information requested can include, for example, whether the user is listening to a certain station on the radio, whether their gas tank is empty, whatever information the vendor wants. They can send that request out 902. The desired information will be returned 904. The information returned can then be sent on to the vendor if specified 906, or to a selection of vendors if it was initiated by the system 11. The vendor can then send back an indication what it would like to do based on the received information 908. That is sent down to the user 910, if the receipt exists, the receipt is returned to the system 912, and then some internal accounting occurs 914.

FIG. 12 illustrates the program flow for the shopping list feature referred to earlier in connection with FIG. 6. The user first enters desired items into the system at step 1100, whether it is wireless or done through a computer, as described above. It can be fairly diverse information, such as a need to get wiper blades, a gallon of milk, and a lawnmower, for example. Those details are entered by the user and the shopping list feature is activated. A subscribing vendor can then offer to provide that product to the user. The method proceeds to check if the user is geographically near a subscribing vendor at step 1010. If not, the system checks to see if a route can be calculated to place the shopper by a subscribing vendor at step 1012. The method then checks to see if the vendorS have one or more of the items on the person's shopping list in stock at step 1014. If they don't, then method flow returns to a point where it waits until some vendor does.

If the answer is yes, that product can be offered to the user. The system 11 then notifies the user of the time, the cost and the location of getting the listed item at step 1016. The time is important because some vendors may have the item up front, with somebody waiting for the user to stop by. The user then has the information needed to decide to make the purchase or to wait until another time in the future (step 1018). Since the request was sent to the vendor if they had these items, the system 11 lets the vendor know if that the user decided not to make a purchase at this time at step 1022. If the user decided to make a purchase, the system 11 notifies the vendor at step 1020 to prepare the order. The method then proceeds to attempt to fill up the rest of the person's shopping list.

The ability of a customer to receive information can be a benefits-based service. The ad is sent when a portion of the user information pool indicates it would be useful for the user (e.g., running out of gas, oil is in need of a change, your run flat tire has low air pressure).

Another application is a person will accept ads at any time for any reason, but limits the number in a time period (e.g., no more than 5 ads per day forming a quota). The limit may be set so large as to approach a free flow of ads based on the user's information pool. A shopping list can also be used to provide a positive service to the user. The event-based service ads should be viewed positively.

Alternatively, the system could present time, availability, and price information on all purchases, and a purchasing decision could be made on all items on the shopping list at one time. Multiple vendors may respond to a user's list. These responses can be forwarded to the user for the user to pick and choose among the vendors for each item. The user could choose or automatic choices could be made based on the user's preference for a route, price, time, or past experiences with different vendors. After the choices have been made, the vendors are informed of the user's choices. An alternative is if price is the main driver, a bidding loop could occur on each item, or for groups of items. This auctioning for the business of a person who is known to be ready to buy items on their shopping list provides vendors with an opportunity to reach a customer ready to make a purchase

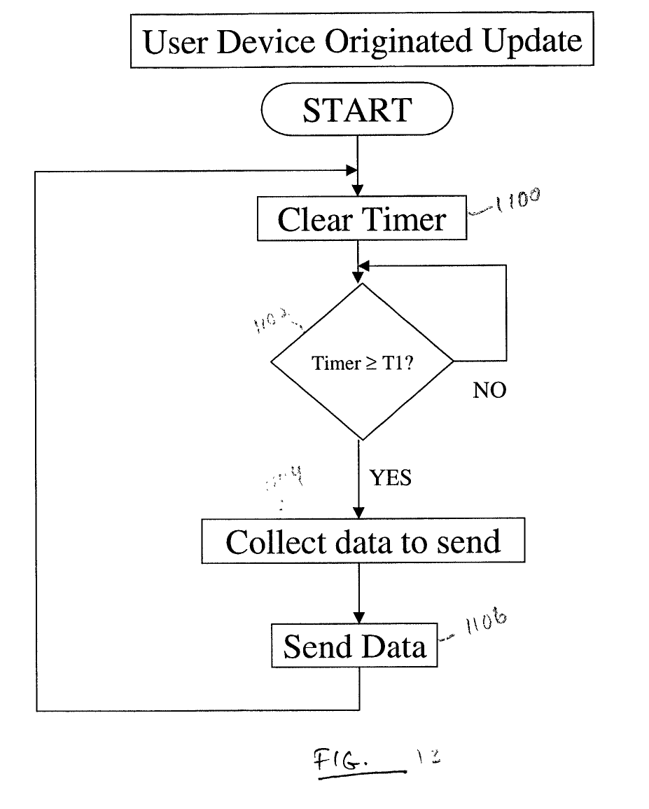

In FIG. 13, a flow chart of the user originated update process is shown. The program starts and the method clears an event timer at step 1100. Again, the timer doesn't necessarily need to measure time. The measured data alternatively could be miles, or it could be uses of something or product. If the timer has exceeded the value looked for at step 1102, then the system 11 collects the data that is going to be sent out at step 1104 and the data is sent at step 1106. If the answer is no, the method loops back and keeps waiting for the timer to time out. This process correlates to steps 800 and 808 in the ladder diagram shown in FIG. 10.

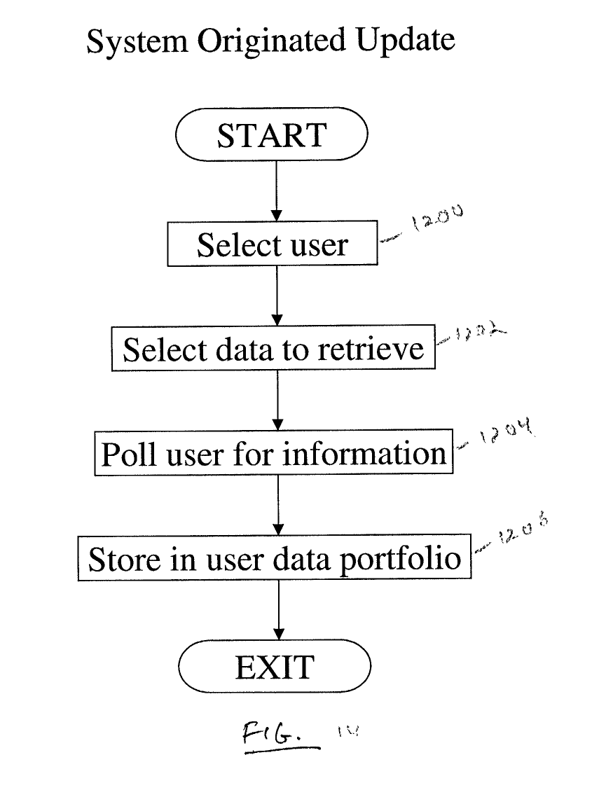

Now, referring to FIG. 14, a system originated update program flow is described. First, a user is selected at step 1200. Then, the system 11 selects the data you want to retrieve at step 1202. The system 11 then polls the user base for that information at step 1204. Once the requested data is received, the system 11 stores it into the portfolio for a particular user at step 1206 and exits. Again, the process shown in FIG. 14 could be based on a time or alternate criteria.

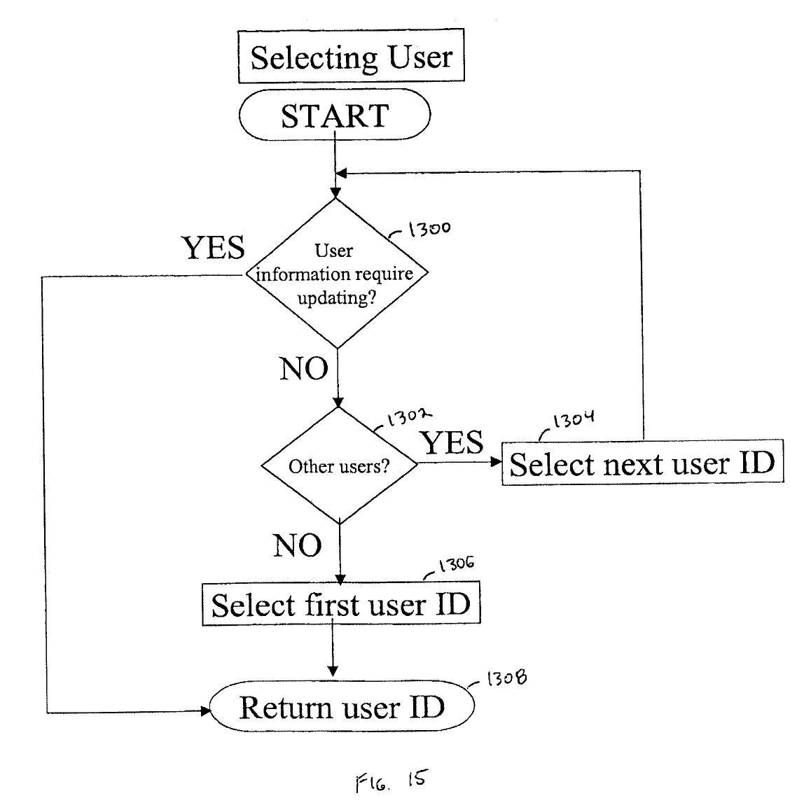

In FIG. 15, a flow chart for selecting a user is illustrated. The method starts by determining at step 1300 if any user information require updating at this time. If the answer is yes, then the system 11 returns that user ID to go out and proceeds to obtain the information from the particular user. If there are other users that also require updating, that is determined at step 1302 and the method selects the next user ID at step 1304. If not, the user ID is returned at step 1308 and the method terminates.

As described in detail above, if there is a navigation planning system that is part of the user's vehicle 184, the information from that system can be used to determine where the vehicle 184 is going to be in the future and that route, or the sequence of locations, could be used when comparing against the criteria in the database. So in the oil change example, if the vendor is interested in anybody within a mile radius, the system 11 can predict that the user will be within a mile and that might be sufficient to satisfy their criteria that runs in the retailer's ad.

Alternatively, location could be obtained from a dead reckoning system rather than a GPS system. For example, current cellular systems can provide ID of the cellular tower that users are near at any point in time. Some of the geography data also may not need a lot of precision. Resolution down to part of a city may be sufficient in certain instances.

The location information can also be dynamic. It can change over time. This allows the vendors to pick different criteria, and different ads. The location information is associated with a particular user, so it is not a static location like zip code or area code. Rather, it is the location of this particular user at this time and over time. As mentioned above, the ad is delivered to the user when the system 11 decides to deliver it and not necessarily when the user is interested in seeing the ad.

As mentioned above, in the preferred embodiment, an override for emergencies or special situations is provided, so the user can respond to the system 11 that it does not want to receive advertising For example, in the process of driving a child who is bleeding to the hospital, the user can respond automatically “please don't bother me with that ad.”

In another aspect of the invention, ads can be tied to services, for example, if a user is going to request a sports update, an ad is delivered and then the sports update or then the weather. In situations like emergency situations, the user can override that feature. For example, a tornado is coming and the user really needs to see the weather. The user does not want to see the ad for what's on t.v. this weekend, however, at that time.

Other ideas for advertising delivery include, for example, delivery of content specific advertising depending upon what information or data the user is receiving on his device. For example, if a user is listening to the football game on the radio, the system 11 may want to send the user a relevant ad, such as an ad for team apparel or tickets to future games of the home team. The system 11 could use a change in status, one of these sensors to trigger an ad to be sent. For example, rather than waiting for the polling or the time to expire, if the oil light turns on, that would send an update back to the system 11 and the system 11 would respond with an oil change advertisement.

The user preferably can input their own advertising preferences, as described above. So, if users are interested in seeing ads for McDonalds but not in seeing ads for a high end steak place, then that is accounted for by the system 11. The system 11 can look at previous purchasing behavior to help identify which ads should be sent. For a given criteria area, the system 11 can ask what is the probability the person will make a purchase? The vendor may want to limit it to a certain level. A 50% or higher probability, for example, and a vendor may then definitely want to send them an ad.

There might be certain stores or certain types of products vendors are more interested in than others. The system 11 could look at a user's wireless device usage and habits, and use some of that information to try and decide when is it more opportune to send advertisements. Some of the spending habits is just feedback from vendors, perhaps, as to what is the likelihood that the user may purchase upon seeing an ad. If that information is recorded by vendors as the reason a customer is buying this product today, the vendor may want to take that into account.

In choosing an ad for a given merchant which might have more than one ad the system 11 can look at several different things to determine which ad to send, or create the ad that would be sent. The system 11 can look at the activity of the user, spending habits, demographics, time of day, time/location history of the user, and at a planned route if navigation is tied in. Regarding spending habits, if a user is going into a store, why send an ad for $0.50 off a sandwich at the deli when a person typically spends $1,000 on jewelry. The system 11 optimises advertising by including other purchase history, and helps build the demographics, or the spending habits of this person. The method of delivery of an ad may be a short textual message. Other data protocols can be used, such as voice ads.

It is to be understood that a wide range of changes and modifications to the embodiments described above will be apparent to those skilled in the art and are contemplated. It is therefore intended that the foregoing detailed description be regarded as illustrative, rather than limiting, and that it be understood that it is the following claims, including all equivalents, that are intended to define the spirit and scope of the invention.

We claim:

1. A method of providing service in a wireless communication network comprising the steps of:
providing a plurality of service options to an end user;
providing products or services to said end user in response to the subscription to one of said service options; and
providing ads to the end user as compensation for the service.
